(19) United States
(12) Patent Application Publication
(10) Pub. No.: US 2017/0144197 A1
(43) Pub. Date: May 25, 2017

(54) Brush

(71) Applicant: Rubia Byrd, Tallahassee, FL (US)

(72) Inventor: Rubia Byrd, Tallahassee, FL (US)

(21) Appl. No.: 14/948,356

(22) Filed: Nov. 22, 2015

(51) Int. Cl. B08B 1/00; B08B 9/04; A46B 9/00; B25G 1/06; B25G 1/04

(52) U.S. Cl. CPC B08B 1/002; B25G 1/06; B25G 1/04; A46B 9/005; B08B 9/04

(57) ABSTRACT

A brushing device which includes a forward end, an aft end, and a member there between. Preferably, the aft end includes a handle. In some embodiments, the member is retractable. In a preferred embodiment of the present invention, the forward end includes a base, a brushing component, an angle adjustment mechanism, and an attachment mechanism. Preferably, the brushing component of the present invention is attached to the base such that the brushing component extends outward laterally from the base at an angle with the horizontal plane which is less than 90 degrees. In some embodiments of the present invention, the base of the brushing device is triangular. However, some embodiments of brushing device include a round or rectangular base. In addition, the brushing component can take many forms. One such form is bristles. In some instances, the brushing component is a sponge.

### BACKGROUND OF THE INVENTION

1. Field of the Invention

This invention relates to the field of brush devices. More specifically, the invention comprises a brushing device which is capable of accessing places which are difficult to reach.

2. Description of the Related Art

The difficulty of reaching corners and baseboards when cleaning and painting has long been recognized. This is true while mopping a floor, cleaning or painting walls, cleaning a shower, and washing base boards or ceiling molding. In the case of mopping a floor, it is difficult to reach the corners of a floor with a traditional mop. Even with a mop that is capable of reaching the corners of a floor, such as a rectangular foam mop, the mop just forces the dirt into the corners. This leads one wishing to clean the corners of a floor to use a brush with bristles. However, such a brush is typically rectangular and includes bristles which are vertical, thereby forming a 90 degree angle when in use. Vertical bristles do not allow the user to easily reach the corner due to the presence of the handle and part of the brush holding the bristles. Due to the bristles extending vertically downwards, the user must try to “dig out” the corner in order to clean a typical corner.

The same issue is present when cleaning or painting walls. The corners cannot be reached using a paint roller. Thus, a paint brush must be used to paint each wall on each side of the corner. This is time consuming and typically requires a latter in order to reach the entire wall. This may be true for a user cleaning or dusting a wall as well.

In addition, baseboards and ceiling moldings are difficult to clean using traditional cleaning supplies. A typical mop often fails to deliver enough force to clean baseboards. This usually results in the user cleaning the baseboards using a towel. In the case of ceiling moldings cleaning using a rag is typically not an option. Thus, another method must be carried out, such as using a duster with a long handle. Unfortunately, a duster spreads dust throughout the area below the ceiling moldings.

Similar to the issues presented when cleaning a floor, the corners of a shower present even more of an issue. Soap and water buildup accumulate in the corners of a shower. This buildup requires a brush with individual bristles and typically a relatively caustic cleaning solution. A typical prior art mop or foam sponge/mop simply does not clean out the corners. As discussed in the preceding text, a typical brush requires the user to “dig” at the corner in order to remove built up water and soap. Therefore, what is needed is a device that allows the user to easily and effectively reach the corners of floors, walls, and showers while cleaning, painting, or dusting. The present invention achieves this objective, as well as others that are explained in the following description.

### BRIEF SUMMARY OF THE INVENTION

The present invention comprises a brushing device which includes a forward end, an aft end, and a member there between. Preferably, the aft end includes a handle. In some embodiments, the member is retractable. In a preferred embodiment of the present invention, the forward end includes a base, a brushing component, an angle adjustment mechanism, and an attachment mechanism. Preferably, the brushing component of the present invention is attached to the base such that the brushing component extends outward laterally from the base at an angle with the horizontal plane which is less than 90 degrees. This results in a more effective cleaning, scrubbing, sweeping, and painting technique.

In some embodiments of the present invention, the base of the brushing device is triangular. However, some embodiments of brushing device include a round or rectangular base. In addition, the brushing component can take many forms. One such form is bristles. In some instances, the brushing component is a sponge.

### BRIEF DESCRIPTION OF THE SEVERAL VIEWS OF THE DRAWINGS

FIG. 1 is a perspective view, showing a preferred embodiment of the present invention.

FIG. 2 is a perspective view, showing the base and brushing component of the present invention.

FIG. 3 is a perspective view, showing the embodiment of FIG. 1 being used in the lower corner of a room.

FIG. 4 is a perspective view, showing the embodiment of FIG. 1 being used in the upper corner of a room.

FIG. 5 is a perspective view, showing the attachment mechanism and angle adjustment mechanism of the present invention.

FIG. 6 is a perspective view, showing an alternated embodiment of the present invention cleaning the baseboards in a room.

FIG. 7 is a perspective view, showing another embodiment of the present invention.

FIG. 8 is a perspective view, showing the embodiment of FIG. 7 cleaning the drain in a sink.

FIG. 9 is a perspective view, showing a hand-held embodiment of the present invention.

FIG. 10 is a perspective view, showing another hand-held embodiment of the present invention.

### REFERENCE NUMERALS IN THE DRAWINGS

10 brushing device

12 forward end

14 aft end

16 member

18 handle

20 brushing component

22 base

24 attachment mechanism

26 angle adjustment mechanism

28 button

30 bristles

32 attachment member

34 channel

36 floor

38 wall

40 corner

42 ceiling corner

44 sponge

46 wall junction

48 receiver

49 opening

50 protrusions

52 tab

54 tab release

56 central gear

58 stationary gear

60 teeth

62 angular release

64 baseboard

66 sink

68 opening

70 drain

72 top surface of drain

74 inner drain wall

### DETAILED DESCRIPTION OF THE INVENTION

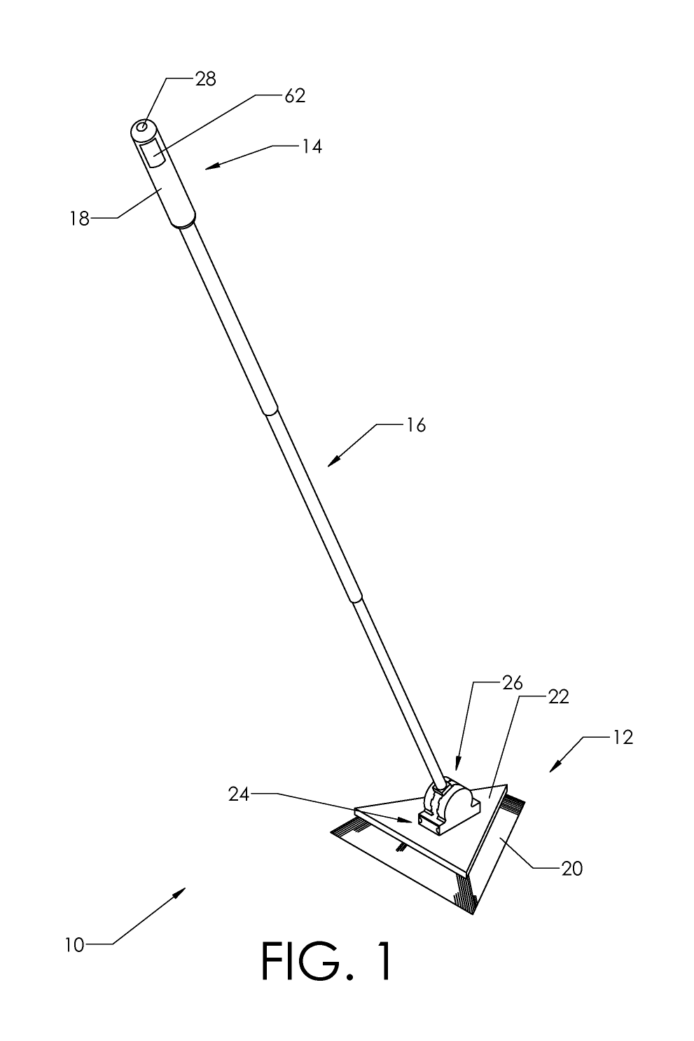

The present invention provides a brushing device for use in various hard-to-reach places around a household or workplace. FIG. 1 shows a preferred embodiment of the present invention. Brushing device 10 includes forward end 12, aft end 14, and member 16. As illustrated, member 16 connects forward end 12 to aft end 14. Aft end 14 includes handle 18. Forward end 12 includes brushing component 20 which is attached to base 22. As shown, brushing component 20 is attached to the bottom side of base 22. The top side of base 22 includes an attachment mechanism 24. In some embodiments of the present invention, base 22 is integral to member 16. However, member 16 is preferably removably attached to base 22 as illustrated in FIG. 1. Brushing device 10 includes an angle adjustment mechanism 26, which allows the user to adjust the angle of member 16 with respect to the horizon.

Member 16 preferably comprises multiple sections of hollow tubing. These sections progressively decrease in outer diameter in order to allow member 16 to telescopically extend and retract. One embodiment uses an internal locking mechanism which is in a normally closed state. Then, when the user presses button 28, the locking mechanism opens, and member 16 can be extended or retracted. The details of such a mechanism are well known in the prior art.

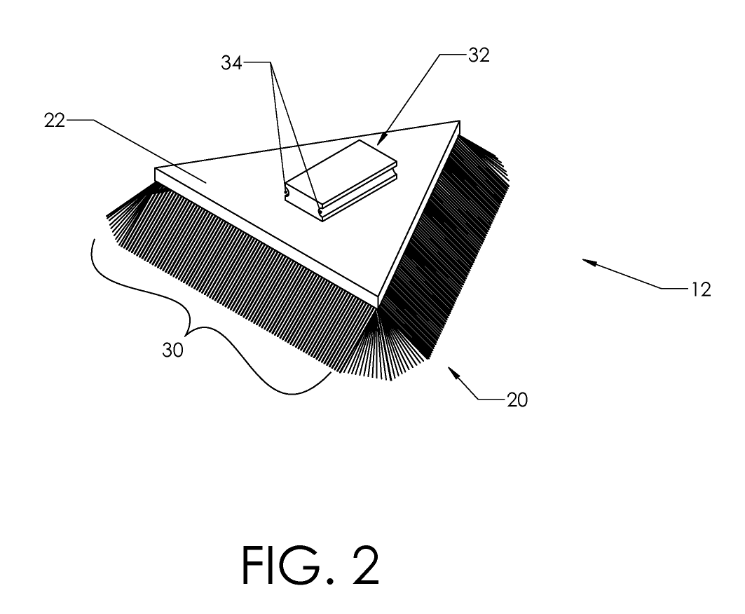

FIG. 2 shows forward end 12 of the present invention. In this embodiment, brushing component 20 comprises a plurality of bristles 30. In addition, base 22 is triangular. Bristles 30 are attached to base 22, as shown. Preferably, bristles 30 are angled outward from base 22 such that the angle between the bristles 30 and an imaginary horizontal plane (or base 22 itself) is less than 90 degrees. Thus, bristles 30 extend outward beyond base 22 around the entire periphery of base 22. Brushing component 20 form angled points at each corner.

A few advantages are derived from bristles 30 extending outward beyond a triangular base 22. Those advantages as applied to using brushing device 10 as a cleaning device are as follows. First, each point created by bristles 30 (at the three points of the triangle) greatly assist with removing dirt and debris from corners. With a point, as opposed to a line or array, bristles 30 can access the entire corner much more easily. Second, the triangular shape, as opposed to the rectangular shape of prior art cleaning brushes, allow for easier access to corners throughout a room. A rectangular base 22 may become jammed in a corner even if bristles 30 are pointed, thereby limiting access to the corner. Third, the triangular shape coupled with the outward extending bristles allow a user to easily clean a corner of a room from floor to ceiling. This is quite a difficult task with a standard rectangular brush. Finally, the shape of base 22, the extension of bristles 30, and the firmness of bristles 30 allow the user to dig out built up dirt and debris left in the corners of a room or shower.

The top portion of base 22 preferably includes attachment member 32. Attachment member 32 is one of two components of attachment mechanism 24. Attachment member preferably includes channels 34. Although channels 34 are shown as semi-circular in the figure, channels 34 may take another shape such as rectangular, triangular, dovetail, “T” slot, or any other known channel profile.

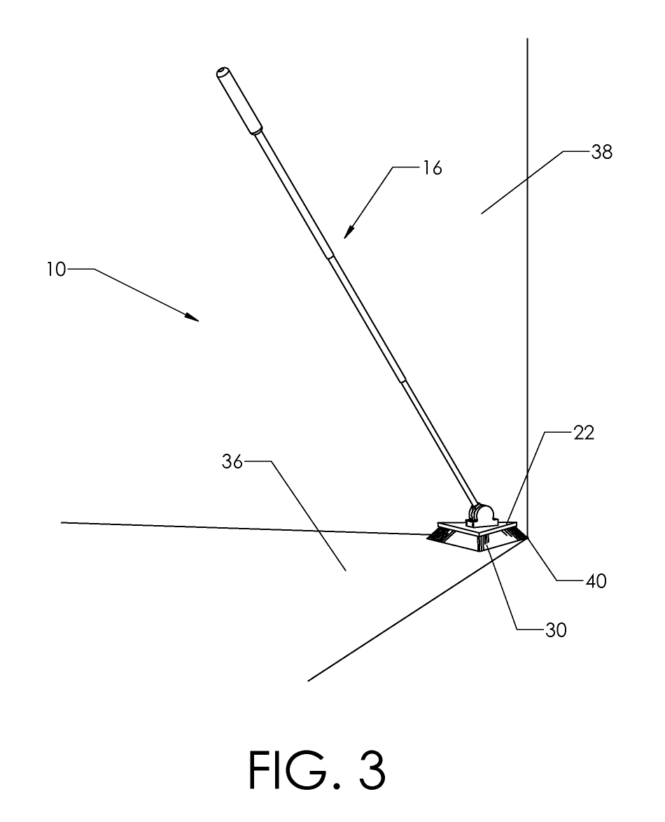

FIG. 3 shows one application of brushing device 10. In this application, brushing component 20 (in this case brushing component 20 is a plurality of bristles 30) is placed on floor 36. As shown, floor 36 and two walls 38 join at a single point in order to create corner 40. Those familiar with the art will realize that brushing device 10 is much more adept at reaching dirt and other debris which has accumulated in corner 40. This is due to the shape of base 22 and the extension of bristles 30 laterally from the perimeter of base 22.

The reader will note that member 16 comprising multiple telescoping tubes allows the user to adjust the height of brushing device 10 for multiple reasons. For instance the height of member 16 may be adjusted in order to accommodate the height of the person using brushing device 10 or to reach a high or hard-to-reach portion of a room.

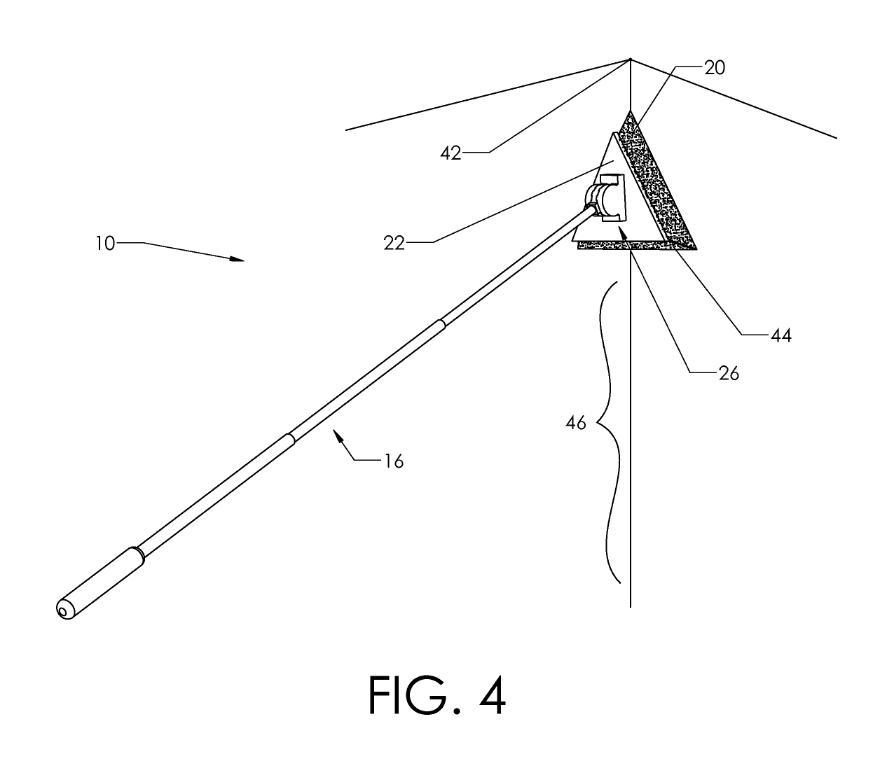

FIG. 4 shows an example of brushing device 10 accessing a hard-to-reach area. Ceiling corner 42 is easily accessible using brushing device 10. As shown, the extension feature of member 16 and the ability of angle adjustment mechanism 26 to adjust the angle of brushing device 10 allows a user to reach even a high ceiling. A few different embodiments of brushing component 20 may be useful for this application. Of course, one embodiment of brushing component 20 can be bristles 30 as shown in FIG. 2. However, in some instances a duster material that attracts dust particles would be useful to clean ceiling corner 42. This would prevent dust and other debris from falling to the floor while cleaning.

In yet another embodiment, brushing component 20 is fabricated using a sponge material. One application as brushing component 20 as a sponge 44 is to paint the junction formed by two joining walls. The shape of base 22 and sponge 44, and lateral extension of sponge 44 would significantly increase the ease of painting wall junction 46. Those familiar with the art will know that a roller is not capable of reaching wall junction 46 due to its cylindrical shape. Thus, this embodiment of the present invention allows a user to easily and quickly paint wall junction 46. Of course, brushing component 20 may be comprised of paint brush bristles as opposed to foam or cleaning-type bristles. Brushing component 20 may take many forms and/or materials allowing for brushing device 10 to be applied to many applications.

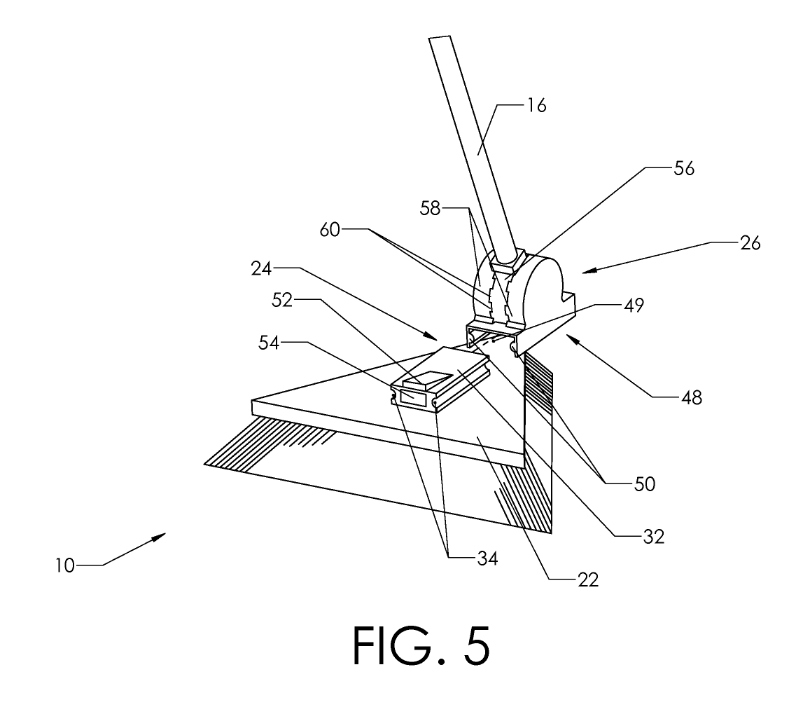

A detailed view of brushing device 10 is shown in FIG. 5. As discussed briefly in the preceding text, attachment member 32 is preferably attached to the top side of base 22. Attachment mechanism 24 comprises attachment member 32 and receiver 48. As indicated by the dashed line, receiver 48 receives attachment member 32. Receiver 48 includes opening 49. Preferably, protrusions 50 fit snugly into channels 34. Once attachment member 32 is fully within receiver 48 a locking mechanism maintains attachment member 32 within receiver 48. This locking mechanism may be released by the user when desired. Attachment mechanism 24 allows the user to remove base 22, and therefore brushing component 20, in order to clean or replace these parts. In addition, multiple shaped bases 22 can be used with the same member 16. Thus, the user can exchange bases 22 when he or she is ready to clean another area of the home or needs to paint with a different color.

The reader will note that protrusions 50 and channels 34 may take many forms. Although a semi-circle is shown for each profile, a dovetail, triangle, “T” slot, or any other suitable profile may be used in order to interlock attachment member 32 and receiver 48.

The locking mechanism used to prevent attachment member 32 from exiting receiver 48 may take many forms. One such form is an inclined snap lock. As attachment member 32 slides into receiver 48, tab 52 is forced downward into attachment member 32. Tab 52 is inclined, allowing receiver 48 to progressively force tab 52 downward as attachment member slides into receiver 48. Then, once attachment member 32 is fully inserted into receiver 48, tab 52 springs upwards (it is naturally biased in this state) into a slot in the inner portion of receiver 48, thereby locking attachment member 32 within receiver 48. In order to release attachment member 32 from receiver 48, the user initiates tab release 54.

In addition, FIG. 5 shows angle adjustment mechanism 26. Angle adjustment mechanism 26 includes receiver 48 and central gear 56. Preferably, receiver 48 includes two stationary gears 58. In a preferred embodiment of the present invention, central gear 56 is connected to member 16. Central gear 56 is capable of rotating relative to stationary gears 58. This allows the user to adjust member 16 with respect to base 22. As shown, central gear 56 and stationary gears 58 comprise a series of teeth 60. In one embodiment of the present invention, the teeth 60 located on central gear 56 are retractable. Thus, when the user presses the angular release 62 (shown as a button in FIG. 1), teeth 60 on central gear 56 retract, thereby allowing the user to change the angular position of member 16 with respect to the ground/base 22. Those familiar with the art will note that although angular release is shown as a button, it could be in the form of a trigger, slider, or any other suitable mechanism.

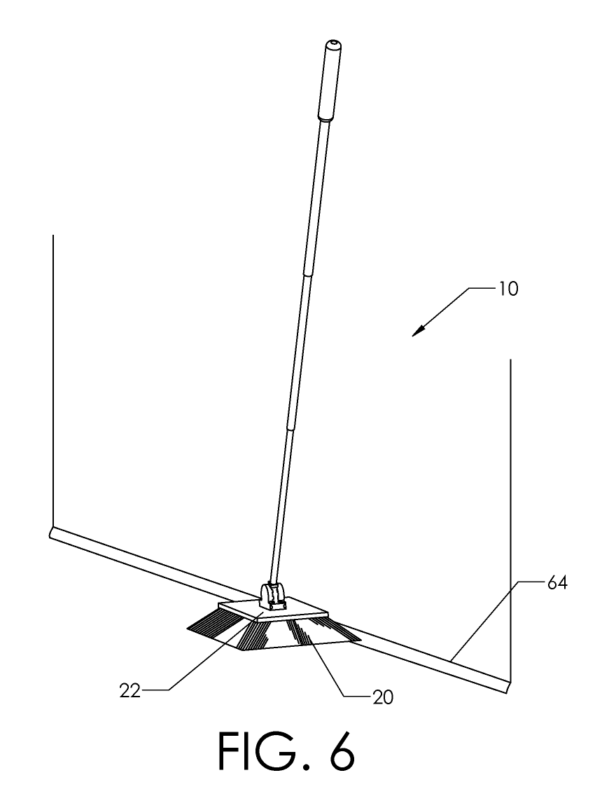

FIG. 6 shows another embodiment of the present invention. In a preferred embodiment of the present invention, base 22 located on brushing device 10 is rectangular. This causes brushing component 20, to extend outwards from base 22 in the form of a rectangle. Although this embodiment of the present invention is not adept at cleaning the junction formed by two walls and a floor or ceiling, it has another application. The first application allows the user to easily and efficiently clean baseboard 64. Baseboards 64 are often difficult to clean or neglected because baseboards are proximate the ground, span the entire room/house/building, and are difficult to clean using standard cleaning tools. Thus, by extending brushing component 20 outwards, the user can easily push brushing device 10 along baseboard 64 in order to clean baseboard 64. This can also be achieved for molding located at the junction between a wall and a ceiling. In this instance brushing component 20 may preferably be a dusting material as opposed to bristles or other material.

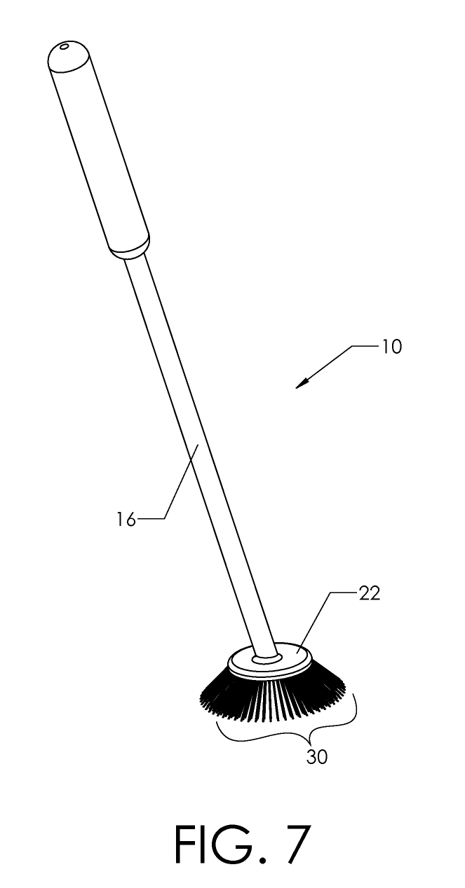

FIG. 7 shows yet another embodiment of the present invention. In this embodiment, brushing device 10 comprises a base 22 which is round. In addition, this embodiment preferably includes a member 16 which is not extendable. A non-extendable/retractable member 16 allows the user to apply a greater amount of force to brushing device 10 than possible with a retractable member 16. As with the other embodiments, bristles 30 span the periphery of base 22. Bristles preferably extend outward at an angle less than 90 degrees from the horizontal. The reader will note that this particular embodiment of the present invention does not include an angle adjustment mechanism 26 or an attachment mechanism 24. In some embodiments of the invention, it is preferable not to include these features.

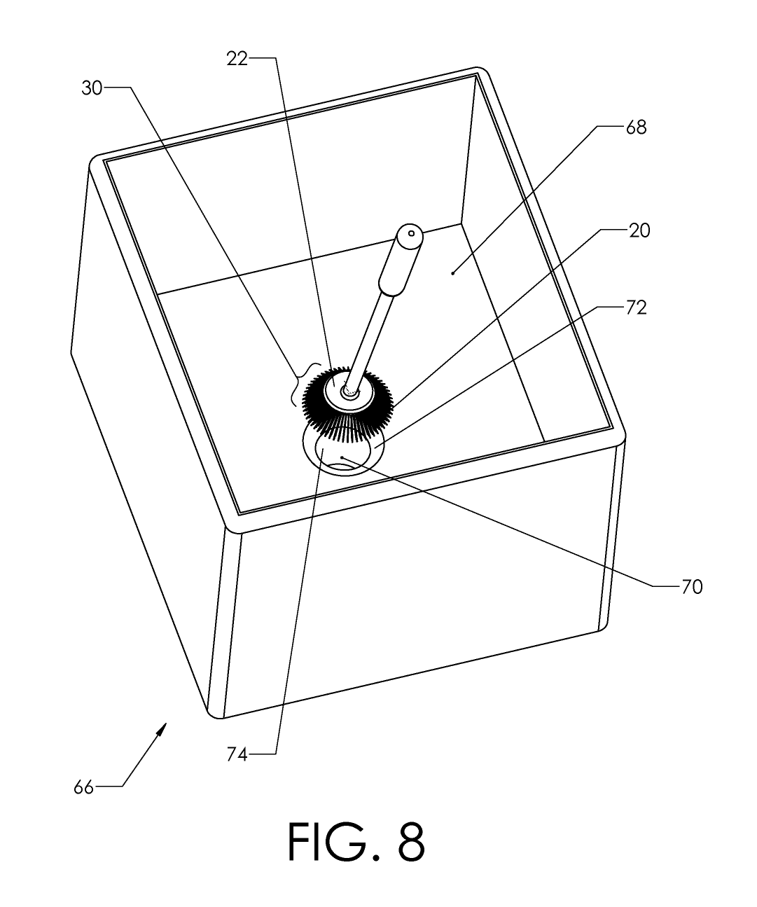

FIG. 8 shows one application of the embodiment of brushing device 10 shown in FIG. 7. Sink 66 includes opening 68 and drain 70. The dimensions of brushing device 10 are such that base 22 and brushing component 20 fit down into drain 70. This allows the user to clean top surface of drain 72 and the inner drain wall 74 as well. The angled nature of bristles 30 allows the user to clean inner drain wall 74 without turning or maneuvering brushing device 10. In fact, when forcing brushing device 10 down into drain 70 on inner drain wall 74 brushing device is very effective at removing water residue due to the angle of bristles 30. In addition, due to the circular shape of base 22, the user can twist the handle 18 of brushing device 10 while he or she moves brushing device 10 up and down within drain 70.

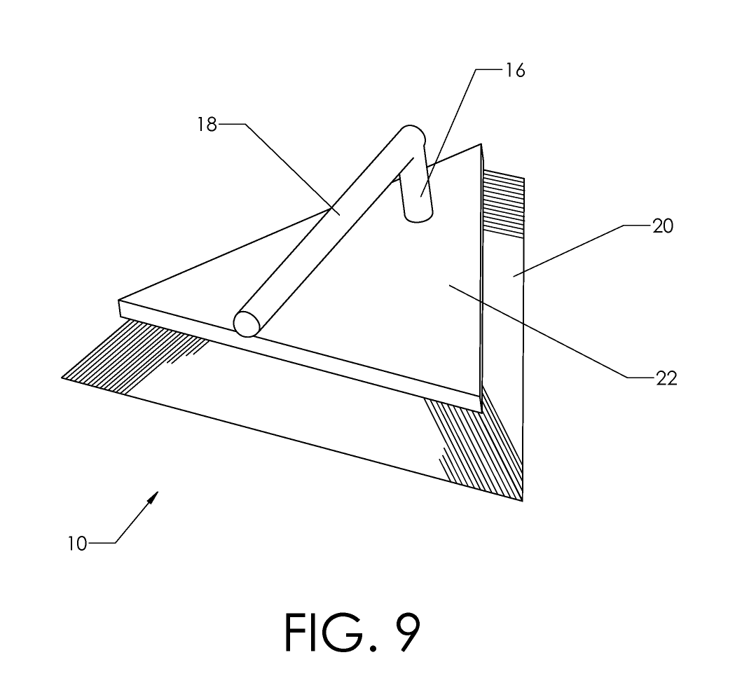

FIG. 9 shows another embodiment of the present invention. Brushing device 10 includes base 22, handle 18, member 16, and brushing component 20. As shown, handle 18 is attached to member 16 which is directly to base 22. Base 22 is triangular. This embodiment of the present invention is intended to be used where either more force is needed or the space is small and a more handheld brushing device 10 is needed. The reader will note that although brushing component 20 is shown as bristles, brushing component may take the form of foam or any other suitable brushing material. Also, in some cases the handle 18 as shown in FIG. 9 is removable using the same technique as shown in FIG. 5. Thus, making base 22 interchangeable with the two different handles. This is useful in a situation where a person is painting the corners of a house. In the areas for which the person painting can easily reach, the embodiment of FIG. 9 is preferred. However, for areas that the user cannot reach, the embodiment of FIG. 1 is preferred. Thus, the user can paint the areas he or she can reach with the handle 18 shown in the embodiment of FIG. 9, and then change to the handle 18 from FIG. 1 to reach the areas which cannot be reached by hand.

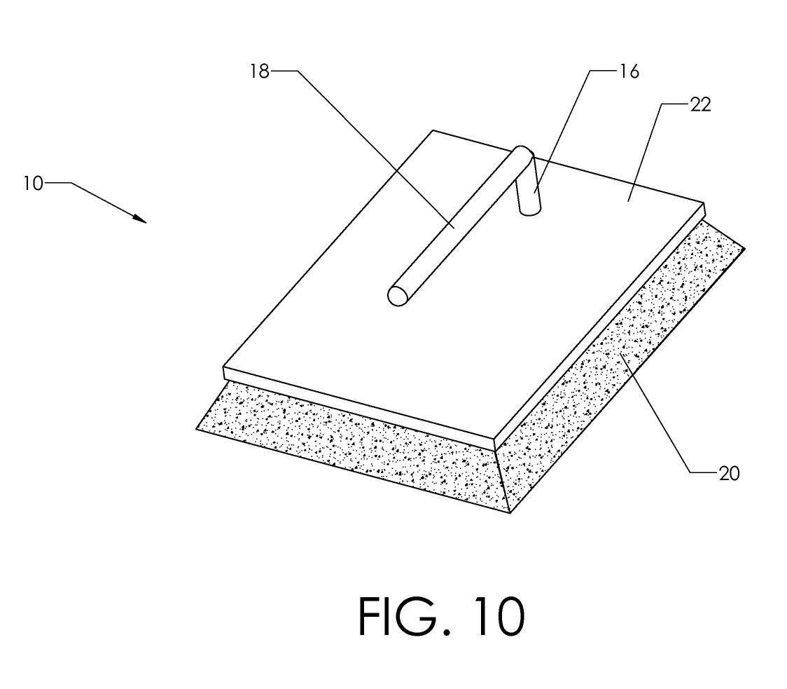

FIG. 10 shows a similar embodiment of the present invention as that shown in FIG. 9. Brushing device 10 includes base 22, handle 18, and brushing component 20. As shown, handle 18 is attached to member 16 which is attached directly to base 22. However, in this instance base 22 is rectangular. This embodiment of the present invention is intended to be used where either more force is needed or the space is small and a more handheld brushing device 10 is needed. The rectangular base 22 and brushing component 20 may be useful for cleaning showers or other similar places. The reader will note that brushing component 20 is foam in the embodiment shown. As with all prior embodiments, brushing component 20 can take many forms.

The preceding description contains significant detail regarding novel aspects of the present invention. It should not be construed, however, as limiting the scope of the invention but rather as providing illustrations of the preferred embodiments of the invention. For example, specific examples of applications have been described in detail. However, the reader will note that the brushing device can be used on many applications. Some other applications for the brushing device of the present invention are windows, window sills, window frames, around projected surfaces such as screws, cracks and crevices in automobiles, or in tight crevices such as screw heads or door thresholds. The shape of the base of the brushing device can also vary based on the specific application. Thus, the scope of the invention should be fixed by the following claims, rather than by examples given.

Having described my invention, I claim:

1. A brushing device, comprising:
a. an aft end and a forward end;
b. a member connecting said aft end and said forward end;
c. a handle attached to said member at said aft end of said brushing device;
d. a receiver attached to said member at said forward end of said brushing device;
e. a base having a top side and a bottom side;
f. an attachment member attached to said top side of said base;
g. wherein said attachment member is removably attached to said receiver; and
i. a brushing component attached to said bottom side of said base.

2. A brushing device as recited in claim 1, wherein:
a. said receiver includes an opening;
b. said opening includes at least one protrusion;
c. said attachment member includes at least one channel designed to receive said at least one protrusion;
d. said attachment member is designed to be inserted into said opening; and
e. said at least one protrusion is designed to translate along said at least one channel.

3. A brushing device as recited in claim 2, further comprising a locking mechanism.

4. A brushing device as recited in claim 3, wherein said locking mechanism, comprises:
a. an inclined tab located on said attachment member;
b. a slot located within said opening of said receiver;
c. wherein said inclined tab is upwardly biased such that when said receiver translates over said tab, said tab is forced downward;
d. wherein said tab is forced upwards into said slot once said attachment member is fully inserted into said opening on said receiver due to said biasing; and
e. a tab release which releases said bias of said tab, thereby allowing said attachment member to exit said opening of said receiver.

5. A brushing device as recited in claim 1, wherein said receiver includes an angle adjustment mechanism.

6. A brushing device as recited in claim 5, wherein said angle adjustment mechanism comprises:
a. a first stationary gear and an identical second stationary gear;
b. a central gear having a first face and a second face;
c. wherein said first stationary gear engages said central gear on said first face and said second stationary gear engages said central gear on said second face;
d. wherein said stationary gears have teeth which correspond to the teeth of said central gear; and
e. said central gear is capable of rotating relative to said first and said second stationary gear.

7. A brushing device as recited in claim 1, wherein said brushing component forms an angle which is less than 90 degrees with said bottom side of said base causing said brushing component to extend outwards laterally from said base.

8. A brushing device as recited in claim 1, wherein said brushing component is a plurality of bristles.

9. A brushing device as recited in claim 1, wherein said brushing component is a sponge material.

10. A brushing device as recited in claim 1, wherein said base is triangular in shape.

11. A brushing device, comprising:
a. an aft end and a forward end;
b. an extendable member connecting said aft end and said forward end;
c. a handle attached to said member proximate said aft end of said brushing device;
d. a receiver attached to said member proximate said forward end of said brushing device;
e. said receiver having an opening, and at least one protrusion;
f. a base having a top side and a bottom side;
g. an attachment member attached to said top side of said base, having at least one channel designed to receive said at least one protrusion located on said receiver;
h. wherein said at least one protrusion and said at least one channel align said attachment member with said opening in said receiver;
i. said attachment member is removably fixed to said receiver using a locking mechanism;
j. a brushing component attached to said bottom side of said base; and
k. wherein said brushing component forms an angle which is less than 90 degrees with said bottom side of said base causing said brushing component to extend outwards laterally from said base.

12. A brushing device as recited in claim 11, wherein said locking mechanism, comprises:
a. an inclined tab located on said attachment member;
b. a slot located within said opening of said receiver;
c. wherein said inclined tab is upwardly biased such that when said receiver translates over said tab, said tab is forced downward;
d. wherein said tab is forced upwards into said slot once said attachment member is fully inserted into said opening on said receiver due to said biasing; and
e. a tab release which releases said bias of said tab, thereby allowing said attachment member to exit said opening of said receiver.

13. A brushing device as recited in claim 11, wherein said receiver includes an angle adjustment mechanism, comprising:
a. a first stationary gear and an identical second stationary gear;
b. a central gear having a first face and a second face;
c. wherein said first stationary gear engages said central gear on said first face and said second stationary gear engages said central gear on said second face;
d. wherein said stationary gears have teeth which correspond to the teeth of said central gear; and
e. said central gear is capable of rotating relative to said first and said second stationary gear.

14. A brushing device as recited in claim 11, wherein said brushing component is a plurality of bristles.

15. A brushing device as recited in claim 11, wherein said member comprises:
a. a plurality of hollow tubes, each having a smaller diameter than the former in order to nest the tubes within each other;
b. said plurality of tubes being in a normally locked position such that said plurality of tubes cannot extend or retract;
c. a button located on said handle; and
d. wherein actuation of said button unlocks said plurality of hollow tubes, thereby allowing said member to extend or retract in length.

16. A brushing device as recited in claim 11, wherein said base is triangular in shape.

17. A brushing device as recited in claim 11, wherein said base is rectangular in shape.

18. A brushing device comprising:
a. an aft end and a forward end;
b. a member connecting said aft end to said forward end;
c. a handle attached to said member proximate said aft end;
d. a base, having a top side and a bottom side;
e. said member attached to said top side of base attached proximate said forward end of said brushing device;
f. a brushing component attached to said bottom side of said base;
g. wherein said brushing component extends outward laterally away from said base, such that a series of angled points are formed.

19. A brushing device as recited in claim 18, wherein said base is circular.

20. A brushing device as recited in claim 18, wherein said base is triangular.
